(19) United States
(12) Patent Application Publication
(10) Pub. No.: US 2025/0222685 A1
(43) Pub. Date: Jul. 10, 2025

(54) A TRIDIMENSIONAL BIODEGRADABLE CONTAINER WITH IMPROVED SENSORY PROPERTIES

(71) Applicant: SOCIETE DES PRODUITS NESTLE S.A., Vevey (CH)

(72) Inventors: JOHANNES ZIMMER, Lausanne (CH); MICHAEL KARLHEINZ HAUSMANN, Boudry (CH); KARSON DURIE, Athens, GA (US)

(21) Appl. No.: 18/850,746

(22) PCT Filed: Mar. 16, 2023
(86) PCT No.: PCT/EP2023/056692

§ 371 Date: Sep. 25, 2024

(30) Foreign Application Priority Data
Mar. 28, 2022 (EP) 22164596.3

(51) Int. Cl. B32B 27/36; B32B 1/00; B32B 27/08

(52) U.S. Cl. CPC B32B 27/36; B32B 1/00; B32B 27/08; B32B 2250/244; B32B 2255/10; B32B 2255/26; B32B 2307/538; B32B 2307/7163; B32B 2307/7248; B32B 2307/7376; B32B 2439/70

(57) ABSTRACT

The present invention concerns a tridimensional hollow container for containing an edible product, said container having a body formed of a first polymeric layer formed of poly hydroxyalcanoate (PHA) having a thickness comprised between 50 μm and 1.5 mm, and wherein: (i) said container body comprises a second layer deposited onto the internal surface of said first layer, and comprising a metalloid, a carbon thin film, or a combination thereof, said second layer having a thickness lower than 100 nm, and (ii) said container body further comprises an intermediate polymeric layer located between said first and second layers, said intermediate layer having a root mean square roughness value (“RMS”) below 20 nm, said intermediate layer having a thickness comprised between 1 and 100 μm.

### FIELD OF THE INVENTION

The present invention concerns a tridimensional container made of polyhydroxyalcanoate (PHA) and further comprising a metalloid barrier layer to improve the sensory properties of the product contained therein.

### BACKGROUND OF THE INVENTION

Containers made of polyhydroxyalcanoate (PHA), especially those containers designed for containing and dispensing edible products, have the advantage of providing consumers with a biodegradable solution, hence environmentally friendly.

Polyhydroxyalcanoates (PHA) are a class of polymers (polyesters) which are relatively easy to transform from a resin (generally having the form of pellets), into tridimensional containers (or packages), through well-known manufacturing processes such as for instance injection-moulding, compression-moulding, or extrusion-blow moulding. Furthermore, PHAs are produced from renewable resources, as they are a by-product of the metabolism of bacteria, which requires reasonably complex transformation steps to be refined into processable polymeric resin.

By “containers”, it is meant not only the containers as such, but also the necessary parts to form a complete packaging, like tridimensional lids or closures for instance.

In spite of their numerous technical and environmental advantages, polyhydroxyalcanoates have a major drawback which is the production of crotonic acid when subjected to heat and/or shear stress during a conversion process, in particular when heating pellets to form molten resin that can be processed into tri-dimensional items, like containers. In this case, when using packaging forming methods as discussed above, the molten PHA resin is heated, and then passes through a forming equipment, for example an extruder, and also possibly the injector part of an injection moulding machine, whereby a high shear stress and temperatures are applied to the PHA molecules.

Due to heat and shear stress, the molecules of PHA are subject to a chemical reaction, more specifically to a hydrolysis step, which degrades the material. As a by-product of this degradation step, so-called crotonic acid is formed.

It was found that containers made from PHA via conventional manufacturing processes, like the ones discussed for example above, contain high amounts of crotonic acid, which was found to exhibit a strong odour which impacts very negatively the sensory properties of the packaged product. This is of course highly undesirable, for quality reasons, and this is especially true for edible products having a low sensory profile, or even more, a neutral sensory profile, like for instance mineral water (either flat or sparkling). In the latter case, consumer tests have shown that the taste of crotonic acid is very much perceived by consumers when drinking water, and is not acceptable.

Furthermore, PHA has also potential additional sensory issues due to bacterial residues after fermentation of residuals of the feedstock which, beyond sensory issues specific to the presence of crotonic acid, may also impact the organoleptic properties of the product contained in packaging made from PHA.

In order to solve this issue, attempts have been made to coat the internal surface of PHA containers (i.e. the surface of in contact with the product), with certain compounds known for their barrier properties. For instance, metalloids like silicone oxide (SiOx) have been tested, which are known for their excellent barrier properties when applied in extremely fine layers which are compatible with biodegradability of the container. Unfortunately, those attempts were unsuccessful as they did not provide sufficient barrier to the migration of crotonic acid from the container walls towards the packed product, and therefore, no substantial and efficient sensory improvement was noted.

Having considered the above, there is a need for PHA containers that can be manufactured with the known forming techniques of the type involving heat and/or shear stress application to a PHA resin, that do not impact on the sensory profile of the container content, especially when said content is an edible product for human or animal consumption, and are biodegradable.

### SUMMARY OF THE INVENTION

The objectives set out above are met with a tridimensional hollow container (or otherwise named “package” in the present specification, which is considered on equivalent wording), for containing an edible product, said container having a body formed of a first polymeric layer, said first layer being formed of polyhydroxyalcanoate (PHA) having a thickness comprised between 50 μm and 1.5 mm, more preferably comprised between 100 and 500 μm, and wherein:
(i) said container body comprises a second layer deposited onto the internal surface of said first layer, said second layer comprising a metalloid, a carbon thin film, or a combination thereof, said second layer having a thickness lower than 100 nm, preferably lower than 80 nm, and
(ii) said container body further comprises an intermediate polymeric layer located between said first and second layers, said intermediate layer having a roughness mean square value (“RMS”) below 20 nm, preferably below 10 nm, said intermediate layer having a thickness comprised between 1 and 100 μm, preferably between 20 and 80 μm.

A tridimensional container thus obtained is preferably rigid, but it can also be semi-rigid, or even have at least some of its constitutive parts which are flexible.

By “polyhydroxyalcanoate (PHA)”, it is meant a whole class of polyester resins from microbial origin, encompassing for instance (but not limited to): poly-3-hydroxybutyrate (PHB), poly-3-hydroxybutyrate-co-4-hydroxybutyrate (P(3-HB-co-4-HB)), poly-3-hydroxybutyrate-co-valerate (PHBV), polyhydroxybutyrate-co-hexanoate (PHBH) and their different grades.

In the preferred embodiment of the present invention, the metalloid used in the second layer is silicon oxide (SiOx), boron trioxide (B₂O₃), germanium dioxide (GeO₂), or a combination thereof, and the carbon film is a diamond-like carbon (DLC). If SiOx is used, the x is preferably comprised between 1.5 and 1.8.

Advantageously, the intermediate layer comprises a polymer selected within the list of: polyethylene terepthalate (PET), polylactic acid (PLA), polybutylene succinate (PBS), polybutylene succinate adipate (PBSA), polybutylene adipate-terephthalate (PBAT), poly-glycolic acid (PGA), starch (TPS), polycaprolactone (PCL), or a combination thereof.

A container according to the present invention is preferably a tridimensional item selected within the list of: food trays, bottles, cans, closures, capsules, pods, lids.

The inventors have surprisingly discovered that by forming an ultra-thin intermediate layer between the first and second layers of PHA and metalloid, the surface of the PHA is provided with a smooth surface at microscopic level, and therefore layer of metalloid (e.g. SiOx) is very homogeneous and well distributed across the surface of the material, such that its barrier effect against crotonic acid migration is greatly improved and solves the sensory issues of such PHA containers.

Such smoothness cannot be achieved with PHA alone, but it was found that this is solved by an additional intermediate “preparatory” layer of a material that is both:
biodegradable by nature, or biodegradable by structure, and
sufficiently smooth as a layer to allow the metalloid subsequent layer to act as an efficient barrier against crotonic acid migration.

The surface roughness is characterized by the “roughness mean square” value (“RMS”) which in the present invention must be below 20 nm, preferably below 10 nm.

The RMS value is determined by the following method.

An atomic force microscope (AFM) scans a sample surface in the lateral directions using a cantilever. The cantilever has a sharp tip which is in permanent contact with the surface. A laser beam is directed to the cantilever tip and reflected into a photodiode. During the scanning process, the cantilever bends as a function of the surface roughness which results in a modified amount of laser light reflected into the photodiode. The height of the cantilever is subsequently adjusted to restore the response signal, which results in the measured cantilever height.

Some polymers are considered good technical choices to provide sufficient smoothness to the PHA layer, per the principle of the invention, in particular:
polyethylene terephthalate (PET) if deposited as an ultra-thin layer by dispersion spray coating (which provides biodegradability by structure);
polylactic acid (PLA), which is bio-based but only biodegradable including a thermal step which triggers the auto-hydrolysis step to start the degradation process in the presence of micro-organisms. Thus, PLA would need to be also applied as an ultra-thin layer by dispersion spray coating to provide biodegradability by structure;
polybutylene succinate adipate (PBSA), which is considered biobased and biodegradable by nature;
polybutylene adipate-terephthalate (PBAT), which is fossil-based but biodegradable by nature;
poly-glycolic acid (PGA), which is considered biobased and biodegradable by nature;
other bio-based and/or biodegradable polymers like thermoplastic starch (TPS)/Polycaprolactone (PCL).

These polymers are applied as an intermediate layer according to the principle of the invention to prepare the deposition of the metalloid barrier layer, as an ultra-thin layer. Said ultra-thin intermediate layer is applied in a way to represent preferably less than 0.3 weight % of the total packaging weight.

The appropriate deposition technique used for applying the intermediate layer is selected within the list comprising: coating processes such as spray coating, aqueous dispersion coating, dip coating, plasma coating, thermal spraying, powder coating. As mentioned above, some of the deposition techniques mentioned will be more appropriate for deposition of certain types of polymers.

In another embodiment of the invention, the intermediate layer is directly co-extruded together with the PHA layer, to form the wall of a tridimensional container, by a conventional extrusion blow moulding process (EBM).

Alternatively, a co-extrusion blow moulding process can be applied, in which the bottle is produced in a single step using a multi-screw co-extruder.

In this process, a PHA tube with a thin internal layer of an additional biomaterial like e.g., PBSA is extruded and subsequently blown into a mould to create a thin internal layer of a bio-degradable material. The inner layer weight in this case can also be reduced to <1% of the total PHA container weight. This process is suitable for materials compatible with PHA. The Compatibility in this case mainly depends on the melting temperature (Tm) and heat stability above Tm respectively. Polymers like PBAT, PBSA and PGA are well suited for such process. As commercially available PHA materials (like for example PHBH or PHBV with a mol % of the co-polymer part) have 130° C.<Tm>180° C., low melting polymers (Tm<100° C.) with a low heat stability above Tm are not suitable to be utilized with PHA. PCL and thermoplastic starch are such candidates which would need to be used rather with the above-mentioned coating technologies.

In the present specification, by “dispersion coating”, it is meant a coating technique whereby an aqueous dispersion of fine polymer particles or polymer solution is applied to the surface of paper or board as such, in order to form a solid, non-porous film after drying. Dispersion coating can be performed by gravure, flexo-gravure, rod, blade, slot-die, curtain air knife, or any other known method of paper coating. Dispersion coating can create a much thinner layer than extrusion, since the polymer is mixed in an aqueous water solution. This brings advantages in terms of quantity of polymer usage, its barrier performance and recyclability of resulting paper structure. The target of dispersion coating is to achieve a barrier layer against water, water vapour, grease, oil, gas, etc. by environmentally friendly coating.

The present invention is further directed to a packaged product comprising:
(i) at least one edible product for human or animal consumption, under liquid, semi-liquid form, powder, gel, kibble or pasty form,
(ii) at least one container according to any of the claims 1 to 6, into which said edible product is packed.

Preferably, said edible product is selected within the list of: mineral water-based beverages, dairy products, sauces, dressings, soups, coffee-based or cocoa-based products, vegetable meat-or fish-alternatives, smoothies, nutritional products for infants or adults, confectionery products, nutritional sport supplements, a pet food

### BRIEF DESCRIPTION OF THE DRAWINGS

Additional features and advantages of the present invention are described in, and will be apparent from, the description of the presently preferred embodiments which are set out below with reference to the drawings in which:

FIG. 1 is a schematic representation of the multilayer structure of a container wall according to the invention, at microscopic level.

### DETAILED DESCRIPTION OF THE INVENTION

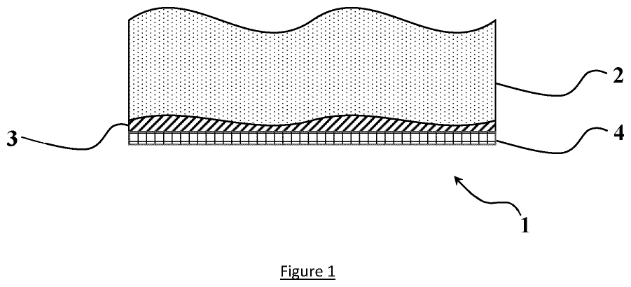

In FIG. 1 is illustrated a preferred embodiment of the invention. In this figure is shown an enlarged view of the wall of a bottle manufactured by extrusion blow moulding of a PHA parison, which is coated on its internal surface after blowing, with additional layers per the invention.

This results in a blown bottle comprising a multilayer structure 1 with the several layers described in the following, starting from the outer layer (i.e. the layer which is in contact with outside atmosphere, once said structure is formed into a package), to the inner layer (i.e. the layer that will eventually be in contact with the packed product).

In the specific example illustrated in FIG. 1, the first—outermost—layer 2 is a polyhydroxyalcanoate (PHA) layer that constitutes the wall of a hollow bottle produced by extrusion blow moulding (EBM) of a PHA resin, through a conventional EBM process. The bottle thus obtained is a 1-liter volume bottle with a screw thread adapted for a screw cap. The cap is made of a polyolefin by injection according to standard manufacturing methods.

The thickness of the PHA layer is not perfectly homogeneous across the surface of the bottle wall, as shown in FIG. 1, said thickness being comprised between 0.25 and 1.3 mm.

In order to smoothen the surface of the PHA layer, a second layer is manufactured, which is intermediate layer 3 illustrated in FIG. 1. The intermediate layer 3 is a co-extruded layer of a polybutylene succinate-co-butylene adipate (PBSA) polymer and it is coated such that the thickness of said intermediate layer is comprised between 10 and 30 μm. As shown in FIG. 1, the innermost surface of the intermediate layer 3 is substantially deprived of irregularities, such that the next layer can then be applied.

The last layer 4 is a silicon oxide (SiOx) layer, which is deposited by a direct plasma coating deposition process. The resulting thin layer of SiOx has a thickness of 40 nm.

The bottle thus obtained was filled with non-sparkling mineral water and closed according to usual processes. It was then stored for a period of 4 weeks at ambient temperature. No noticeable sensory degradation of the water was noted during testing of the bottle contents, which indicates the good barrier properties of the SiOx coating against migration of crotonic acid.

It should be understood that various changes and modifications to the presently preferred embodiments described herein will be apparent to those skilled in the art. Such changes and modifications can be made without departing from the scope of the present invention and without diminishing its attendant advantages. It is therefore intended that such changes and modifications be covered by the appended claims.

1. A tridimensional hollow container for containing an edible product, said container having a body formed of a first polymeric layer, said first layer being formed of polyhydroxyalcanoate (PHA) having a thickness between 50 μm and 1.5 mm, and wherein:
(i) said container body comprises a second layer deposited onto the internal surface of said first layer, said second layer comprising a metalloid, a carbon thin film, or a combination thereof, said second layer having a thickness lower than 100 nm, and
(ii) said container body further comprises an intermediate polymeric layer located between said first and second layers, said intermediate layer having a roughness mean square value (“RMS”) below 20 nm, said intermediate layer having a thickness comprised between 1 and 100 μm.

2. A container according to claim 1, wherein said metalloid is selected from the group consisting of silicon oxide (SiOx), boron trioxide (B₂O₃), germanium dioxide (GeO₂), and a combination thereof, and the carbon film is a diamond-like carbon (DLC).

3. A container according to claim 1, wherein said intermediate layer comprises a polymer selected from the group consisting of: polyethylene terepthalate (PET), polylactic acid (PLA), polybutylene succinate (PBS), polybutylene succinate adipate (PBSA), polybutylene adipate-terephthalate (PBAT), poly-glycolic acid (PGA), starch (TPS), polycaprolactone (PCL), and a combination thereof.

4. A container according to claim 1, wherein said intermediate layer is a co-extruded layer of a polybutylene succinate-co-butylene adipate (PBSA) having a thickness of 10 and 30 μm.

5. A container according to claim 1, which is a tridimensional item selected from the group consisting of: food trays, bottles, cans, closures, capsules, pods, and lids.

6. A packaged product comprising:
(i) at least one edible product for human or animal consumption, under liquid, semi-liquid form, powder, gel, kibble or pasty form,
(ii) at least one container for containing an edible product, said container having a body formed of a first polymeric layer, said first layer being formed of polyhydroxyalcanoate (PHA) having a thickness between 50 μm and 1.5 mm, and wherein:
said container body comprises a second layer deposited onto the internal surface of said first layer, said second layer comprising a metalloid, a carbon thin film, or a combination thereof, said second layer having a thickness lower than 100 nm, and
said container body further comprises an intermediate polymeric layer located between said first and second layers, said intermediate layer having a roughness mean square value (“RMS”) below 20 nm, said intermediate layer having a thickness comprised between 1 and 100 μm, into which said edible product is packed.

7. A packaged product according to claim 6, wherein said edible product is selected from the group consisting of: mineral water-based beverages, dairy products, sauces, dressings, soups, coffee-based or cocoa-based products, vegetable meat- or fish-alternatives, smoothies, nutritional products for infants or adults, confectionery products, nutritional sport supplements, and a pet food.
